(19) United States
(12) Patent Application Publication
(10) Pub. No.: US 2011/0051978 A1
(43) Pub. Date: Mar. 3, 2011

(54) EARPHONE WITH DETACHABLE COVERS

(75) Inventor: HWANG-MIAW CHEN, Tu-Cheng (TW)

(73) Assignee: FOXCONN TECHNOLOGY CO., LTD., Tu-Cheng (TW)

(21) Appl. No.: 12/605,382

(22) Filed: Oct. 26, 2009

(30) Foreign Application Priority Data
Aug. 31, 2009 (CN) 200910306390.4

(51) Int. Cl. H04R 1/10

(52) U.S. Cl. 381/380

(57) ABSTRACT

An earphone includes a shell and a speaker in the shell. The shell includes a front cover and a rear cover joined with the front cover. One of the front and rear covers has a protrusion extending out toward the other one of the front and rear covers, and the other of the front and rear shells defines a fixing groove facing the protrusion. The protrusion is engaged in the fixing groove to join the front and rear covers together.

### BACKGROUND

1. Technical Field

The disclosure generally relates to audio devices, and particularly to an earphone having a front cover and a rear cover joined together conveniently.

2. Description of Related Art

With the continuing development of numerous technologies, earphones have been widely used in different fields, such as telephone communication, audio players, music reproduction, and so on.

A typical earphone includes a shell and a speaker in the shell. The shell includes a front cover and a rear cover. The rear cover is joined with the front cover via adhesive. However, the adhesive tends to decay under the influence of environmental factors such as ambient temperature, humidity and so on, which reduces the adhesive bonding between the front and rear covers.

What is needed, therefore, is an earphone which can overcome the described limitations.

### BRIEF DESCRIPTION OF THE DRAWINGS

Many aspects of the present earphone can be better understood with reference to the following drawings. The components in the drawings are not necessarily drawn to scale, the emphasis instead being placed upon clearly illustrating the principles of the disclosed earphone. Moreover, in the drawings, like reference numerals designate corresponding parts throughout the several views.

FIG. 1 is an assembled, isometric view of an earphone in accordance with one embodiment of the disclosure.

FIG. 2 is an exploded, isometric view of the earphone of FIG. 1.

FIG. 3 is an isometric view of a front cover of the earphone of FIG. 2.

FIG. 4 is an isometric view of a rear cover of the earphone of FIG. 2.

FIG. 5 is a cross sectional view of the earphone of FIG. 1, taken along line V-V thereof.

FIG. 6 is an enlarged, exploded view showing a joint portion between the front and rear covers of the earphone of FIG. 5.

FIG. 7 is an enlarged, exploded view showing another joint portion between the front and rear covers of the earphone of FIG. 5.

### DETAILED DESCRIPTION

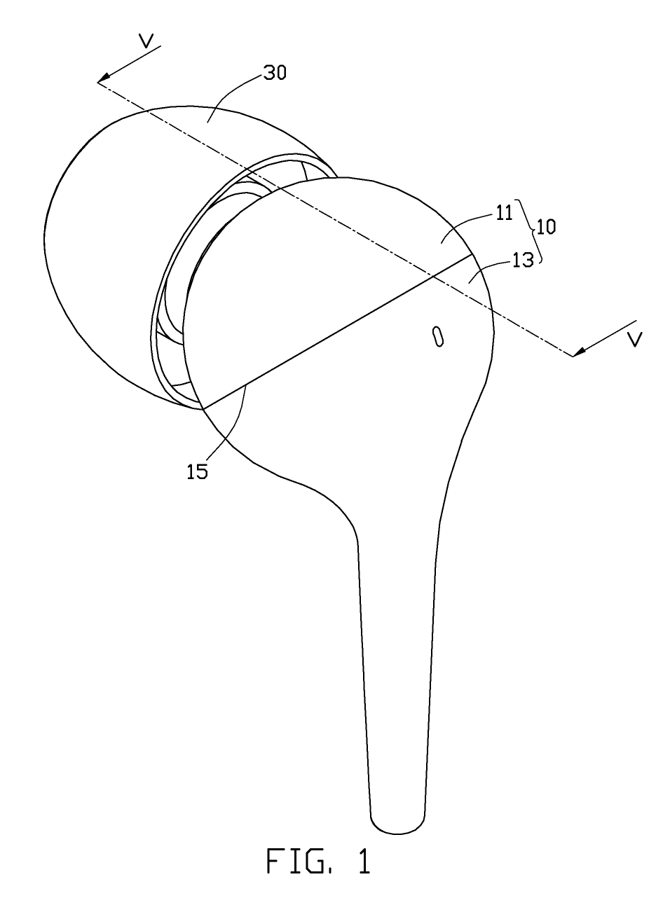

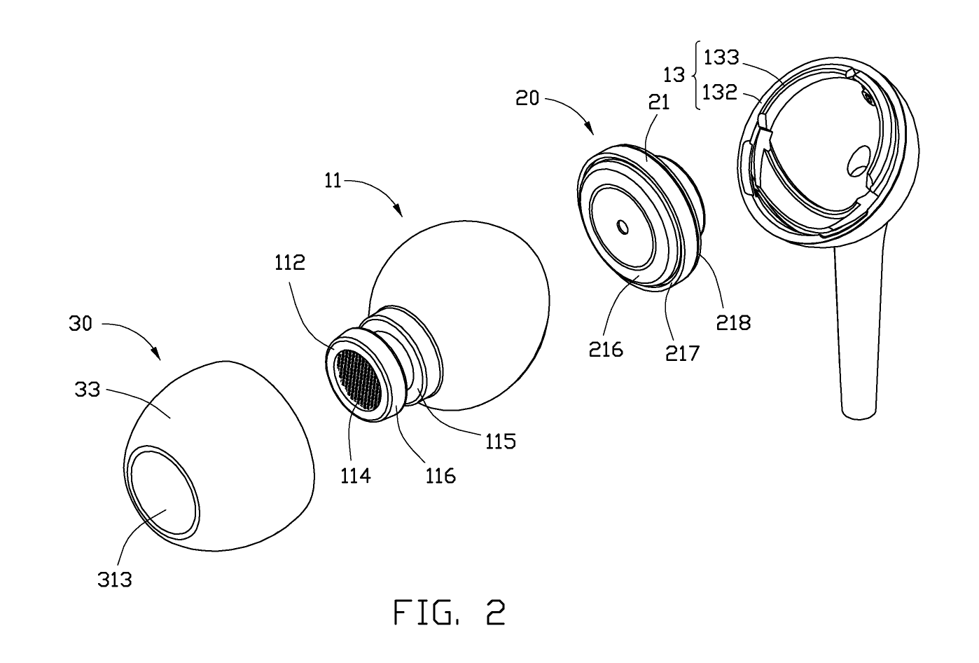

Referring to FIGS. 1 and 2, an earphone according to one embodiment of the disclosure is shown. The earphone includes a shell 10, a speaker 20 received in the shell 10, and a rubber cap 30 at a front end of the shell 10. The shell 10 includes a front cover 11 and a rear cover 13 joined with the front cover 11. A joint plane 15 is defined through a joint portion between the front and rear covers 11, 13.

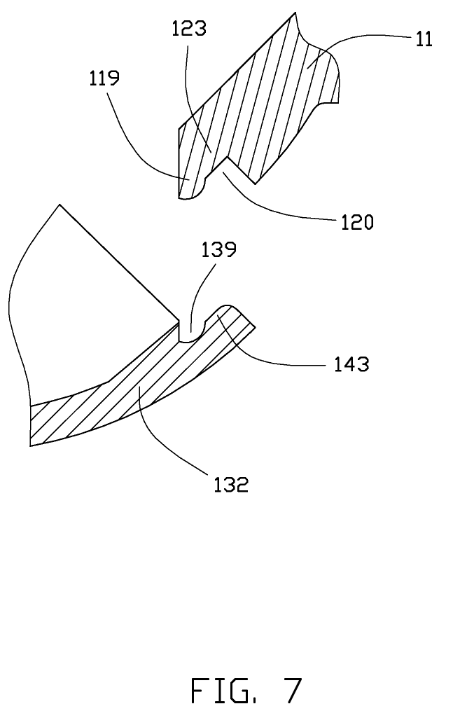

Referring to FIGS. 2, 3, 5 and 7, the front cover 11 is hollow and substantially hemispheric, and defines a front chamber 111 therein. A sound tube 112 extends horizontally and outwardly from a front end of the front cover 11 toward the rubber cap 30. A longitudinal axis of the sound tube 112 is non-perpendicular to the joint plane 15 between the front and rear covers 11, 13. The sound tube 112 is hollow and substantially cylindrical, and defines a sound channel 113 therein in communication with the front chamber 111. A tuning mesh 114 is disposed at a front end of the sound channel 113, for improving the sound quality factor and adjusting the sound sharpness of the speaker 20. The sound channel 113 expands gradually from the rubber cap 30 toward the front cover 11 to form a trumpet shape at a rear end thereof, such that sound from the speaker 20 readily enters the sound channel 113. The sound channel 113 defines an annular joint groove 115 in an outer circumference thereof. The sound tube 112 has an outer diameter gradually decreasing from the joint groove 115 toward the rubber cap 30, thereby forming an inclined outer surface 116 at a front end of the sound tube 112. The inclined outer surface 116 can assist in mounting the rubber cap 30 around the sound tube 112.

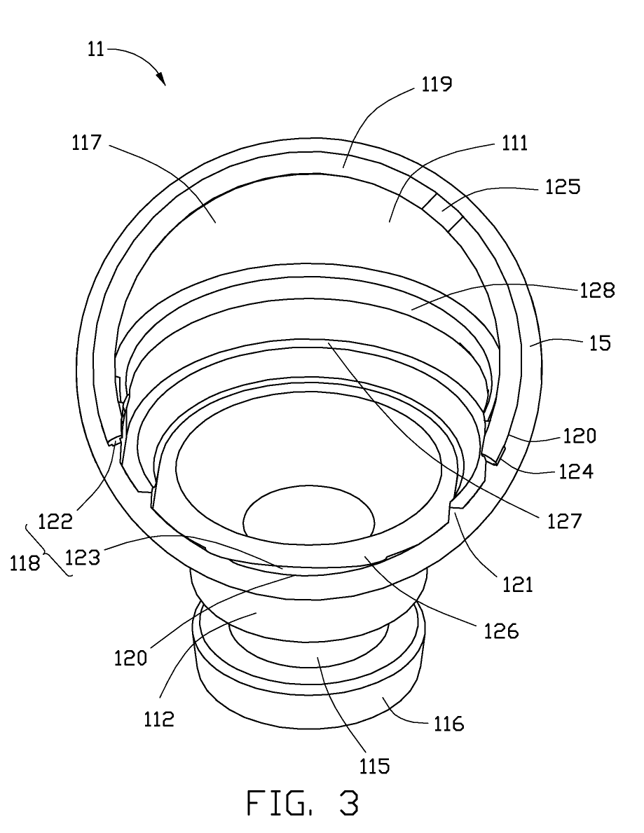

The front cover 11 defines an opening 117 at a rear end thereof. The front cover 11 has a fixing flange 118 extending out from an inner side thereof adjacent to the opening 117. The fixing flange 118 expands outwardly to form a spherical protrusion 119 at a free end thereof, whereby a mounting groove 120 is defined in an outer surface of the fixing flange 118 adjacent to and below the protrusion 119. The fixing flange 118 defines two fixing cutouts 121 (shown in FIG. 3) at left and right sides of a bottom portion thereof, respectively. The two fixing cutouts 121 divide the fixing flange 118 into two parts, i.e., an upper portion 122 above the two fixing cutouts 121 and a lower portion 123 below the two fixing cutouts 121. The upper and lower portions 122, 123 of the fixing flange 118 are located in a circumference. Two blocks 124 (only one shown in FIG. 3) extend respectively out from two opposite sides of the fixing flange 118 into the mounting groove 120. The mounting groove 120 is closed up along a circumferential direction of the front cover 11 by the blocks 124. The upper portion 122 of the fixing flange 118 defines a positioning cutout 125 in a middle thereof.

The front cover 11 forms a first step 126 and a second step 127 at an inner surface thereof, with both the first and second steps 126, 127 facing toward the front chamber 111. The first and second steps 126, 127 are planar, and parallel to each other. The longitudinal axis of the sound tube 112 is perpendicular to the first step 126. In other words, the first step 126 is nonparallel to the joint plane 15 between the front and rear covers 11, 13. The first step 126 is located below the second step 127 (as viewed in FIG. 3). The first step 126 is located adjacent to the sound tube 112, and cuts the lower portion 123 of the fixing flange 118 into a triangle shape. The protrusion 119 of the lower portion 123 of the fixing flange 118 is also cut into a hemispheric shape by the first step 126. The front cover 11 further has a semicircular positioning flange 128 protruding out at the inner surface thereof toward the front chamber 111. The positioning flange 128 is located above the second step 127 (as viewed in FIG. 3). A central plane 129 of the positioning flange 128 along a circumferential direction thereof is parallel to the first step 126. In other words, the central plane 129 is nonparallel to the joint plane 15 between the front and rear covers 11, 13.

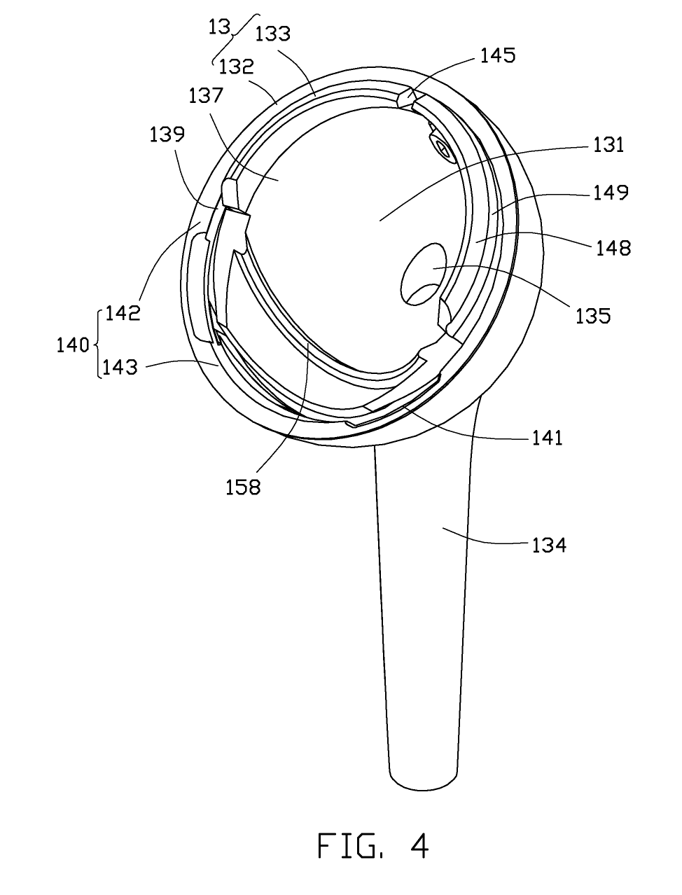

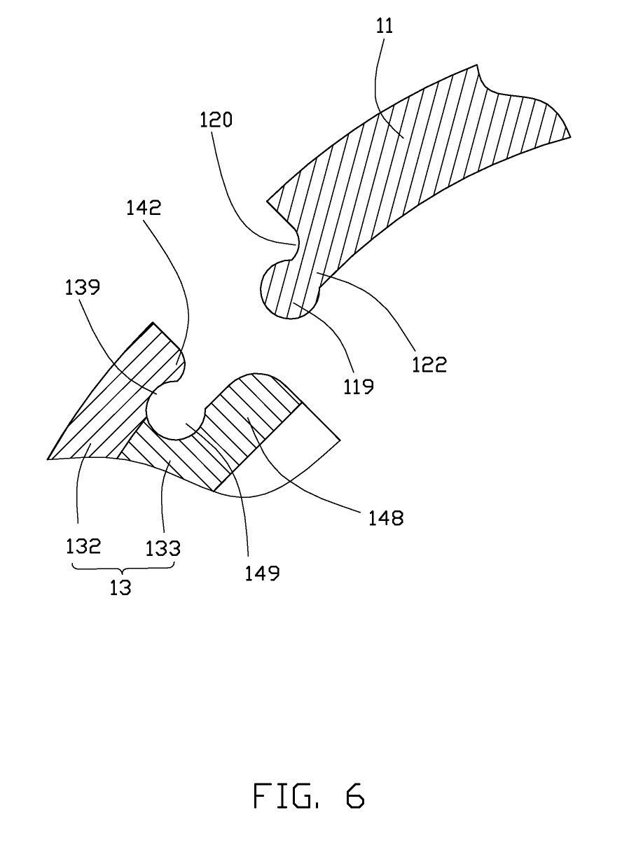

Referring to FIGS. 4-7, the rear cover 13 is also hollow and substantially hemispheric, and defines a rear chamber 131 therein. The rear cover 13 defines an opening 137 at a front end thereof. The opening 137 faces the opening 117 of the front cover 11. The rear cover 13 includes an outer cover 132 and an inner cover 133 in the outer cover 132. The inner cover 133 is made of a rigid material, such as polyvinyl chloride (PVC) and so on, and is for supporting the speaker 20. The outer cover 132 is made of a material which has a rigidity less than that of the inner cover 133 and a toughness greater than that of the inner cover 133, such as rubber and so on, and is for improving a texture of an outer surface of the earphone and preventing a rupture of the earphone.

The outer cover 132 defines an annular and hemispheric fixing groove 139 in an inner surface thereof. The fixing groove 139 is located at a front end of the outer cover 132 adjacent to the opening 137, whereby a mounting flange 140 corresponding to the fixing groove 139 protrudes out at the front end of the outer cover 132. The mounting flange 140 defines two fixing cutouts 141 at left and right sides of a bottom thereof, respectively. The fixing cutouts 141 align with the fixing cutouts 121 of the front cover 11, respectively, such that the speaker 20 is not blocked by the mounting flange 140 of the rear cover 13 and the fixing flange 118 of the front cover 11 during assembly. The two fixing cutouts 141 also divide the mounting flange 140 into two parts, i.e., an upper portion 142 above the two fixing cutouts 141 and a lower portion 143 below the two fixing cutouts 141. The outer cover 132 has a hollow wire duct 134 extending downwardly at a rear end thereof. The wire duct 134 is provided for a wire (not shown) of the earphone to pass therethrough and electrically connect with the speaker 20.

The inner cover 133 is adhered to the inner surface of the outer cover 132. The rear chamber 131 is defined in the inner cover 133. The inner cover 133 has a securing flange 148 extending forwardly out from an inner side thereof adjacent to the opening 137. The securing flange 148 is semi-annular, and is located at a top of the inner cover 133. The securing flange 148 defines a hemispheric fixing groove 149 in an outer surface thereof. The hemispheric fixing grooves 139, 149 of the outer and inner covers 132, 133 cooperatively form a spherical groove, for matching the protrusion 119 of the front cover 11. The securing flange 148 defines a positioning cutout 145 aligning with the positioning cutout 125 of the front cover 11 in a middle thereof, whereby the front and rear covers 11, 13 can be positioned accurately during assembly.

The inner cover 133 has a semicircular positioning flange 158 protruding out at an inner surface thereof toward the rear chamber 131. The semicircular positioning flanges 128, 158 of the front and inner covers 11, 133 cooperatively form a circular flange. The inner cover 133 defines a through hole 135 in a rear end thereof, in communication with the wire duct 134 of the outer cover 132.

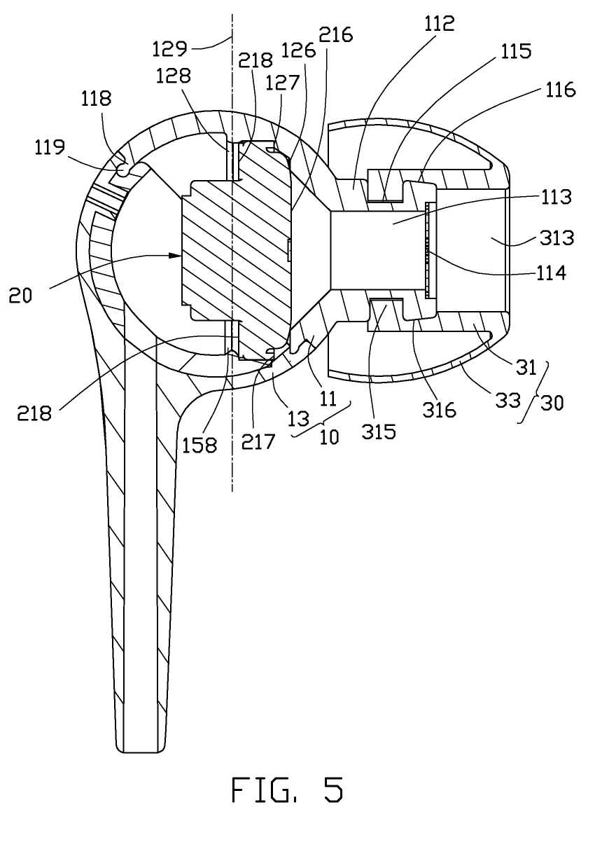

Referring to FIGS. 2 and 5, the rubber cap 30 is typically made of soft rubber material. The rubber cap 30 includes an inner tube 31, and an outer cap 33 bending backwardly out from a front end of the inner tube 31, with the inner tube 31 received in the outer cap 33. The inner tube 31 is hollow and cylindrical, and defines a sound passage 313 therein. The sound passage 313 communicates with the sound channel 113 of the front cover 11. The inner tube 31 has an annular joint flange 315 protruding out from a rear end thereof into the sound passage 313. The joint flange 315 is engaged in the joint groove 115 of the sound tube 112 of the front cover 11. A height of the joint flange 315 is slightly less than a depth of the joint groove 115 along a radial direction of the sound passage 313. The inner tube 31 defines an inclined groove 316 in front of the joint flange 315. A depth of the inclined groove 316 along the radial direction of the sound passage 313 gradually decreases in a forward direction, thereby complementarily matching the inclined outer surface 116 of the sound tube 112.

The speaker 20 includes a frame 21. The frame 21 has a first abutting portion 216 and a second abutting portion 217 at a front end thereof, and a positioning portion 218 at a rear end thereof. The first abutting portion 216 is substantially flat. Each of the second abutting portion 217 and the positioning portion 218 is annular and planar.

During assembly of the earphone, the speaker 20 is pushed into the front chamber 111 of the front cover 11 along the first step 126 from the fixing cutouts 121 of the front cover 11. The first and second abutting portions 216, 217 of the speaker 20 abut against the first and second steps 126, 127 of the front cover 11, respectively. The positioning portion 218 of the speaker 20 abuts against the positioning flange 128 of the front cover 11. The fixing grooves 139, 149 of the rear cover 13 are aligned with the fixing flange 118 of the front cover 11. The positioning cutout 145 of the securing flange 148 of the rear cover 13 is aligned with the positioning cutout 125 of the upper portion 122 of the fixing flange of the front cover 11. The rear cover 13 is pressed toward the front cover 11 until the fixing flange 118 of the front cover 11 is engaged in the fixing grooves 139, 149 of the rear cover 13, with the upper and lower portions 142, 143 of the mounting flange 140 of the rear cover 13 engaged in the mounting groove 120 of the fixing flange 118 of the front cover 11. At this time, two ends of the upper portion 142 of the mounting flange 140 of the rear cover 13 adjacent to the fixing cutouts 141 abut against the blocks 124 of the upper portion 122 of the fixing flange 118 of the front cover 11, respectively. The positioning flange 158 of the rear cover 13 and the positioning flange 128 of the front cover 11 cooperatively form an annular flange. The positioning portion 218 of the speaker 20 abuts against the positioning flange 158 of the rear cover 13 and the positioning flange 128 of the front cover 11.

The rear end of the sound passage 313 of the rubber cap 30 adjacent to the joint flange 315 is aligned with the sound tube 112 of the front cover 11. The rubber cap 30 is pressed toward the front cover 11 until the joint flange 315 of the rubber cap 30 slides into the joint groove 115 of the sound tube 112 along the inclined outer surface 116 of the front of the sound tube 112. At this time, the inclined groove 316 of the inner tube 31 of the rubber cap 30 matches the inclined outer surface 116.

In the earphone, the protrusion 119 of the front cover 11 is engaged in the fixing grooves 139, 149 of the rear cover 13. Thereby, the front and rear covers 11, 13 can be joined together steadily, and the front and rear covers 11, 13 can be attached together and detached from each other conveniently. There is no need to provide adhesive to join the front and rear covers 11, 13 together, thereby mitigating any risk of an insecure joint between the front and rear covers 11, 13 due to decay of the adhesive.

In addition, the mounting flange 140 of the rear cover 13 is engaged in the mounting groove 140 of the front cover 11, which further joins the front and rear covers 11, 13 together. Furthermore, the two ends of the upper portion 142 of the mounting flange 140 of the rear cover 13 adjacent to the fixing cutouts 141 abut against the blocks 124 of the upper portion 122 of the front cover 11, respectively. Accordingly, the rear cover 13 is prevented from rotating along a circumferential direction of the shell 10 after assembly, so that the rear cover 13 is firmly attached to the front cover 11.

Moreover, the first and second abutting portions 216, 217 of the speaker 20 abut respectively against the first and second steps 126, 127 of the front cover 11, and the positioning portion 218 of the speaker 20 abuts against the positioning flanges 128, 158 of the front and rear covers 11, 13. In other words, the speaker 20 is sandwiched between the steps 126, 127 and the positioning flanges 128, 158, which helps to secure the speaker 20 in the earphone. The positioning flanges 128, 158 are respectively formed on the front and rear covers 11, 13, and the central plane 129 of the positioning flange 128 is nonparallel to the joint plane 15 between the first and second covers 11, 13. Accordingly, the speaker 20 can slide into the front cover 11 from an outer side of the front cover 11. That is, it is convenient to assemble the speaker 20 into the shell 10.

Alternatively, the protrusion 119 and the mounting groove 120 of the front cover 11 can be formed on the rear cover 13, and simultaneously, the fixing grooves 139, 149 and the mounting flange 140 of the rear cover 13 are formed on the front cover 11.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An earphone, comprising:
a speaker; and
a shell receiving the speaker therein, the shell comprising a front cover and a rear cover joined with the front cover, one of the front and rear covers having a protrusion extending out toward the other one of the front and rear covers, the other one of the front and rear covers defining a fixing groove facing the protrusion, the protrusion being engaged in the fixing groove to join the front and rear covers together.

2. The earphone of claim 1, wherein a fixing flange extends outwardly from the one of the front and rear covers, the protrusion being formed on a free end of the fixing flange, the fixing flange defining a mounting groove in an outer surface thereof adjacent to and below the protrusion, a mounting flange protruding out from the other one of the front and rear covers corresponding to the mounting groove, the mounting flange being engaged in the mounting groove to further join the front and rear covers together.

3. The earphone of claim 2, wherein the fixing flange has at least one block extending out into the mounting groove, at least one end of the mounting flange abutting against the at least one block to limit rotation of the rear cover relative to the front cover along a circumferential direction of the shell.

4. The earphone of claim 3, wherein the fixing flange defines two fixing cutouts at left and right sides of a bottom thereof, respectively, the fixing cutouts dividing the fixing flange into an upper portion and a lower portion, the at least one block comprising two blocks respectively at two sides of the fixing flange, the mounting groove being closed up along a circumferential direction of the front cover by the blocks, the mounting flange also defining two fixing cutouts at left and right sides of a bottom thereof, respectively, the fixing cutouts of the mounting flange aligning with the fixing cutouts of the fixing flange, respectively, the fixing cutouts also dividing the mounting flange into an upper portion and a lower portion, two ends of the upper portion of the mounting flange abutting against the blocks, respectively.

5. The earphone of claim 1, wherein the front cover is hollow and defines a front chamber therein, the front cover forming at least one step at an inner surface thereof, the at least one step facing toward the front chamber, the rear cover being hollow and defining a rear chamber therein, at least one of the front and rear covers having a positioning flange protruding out at the inner surface thereof, the speaker comprising at least one abutting portion at a front end thereof, and at least one positioning portion at a rear end thereof, the at least one abutting portion of the speaker abutting against the at least one step of the front cover, and the at least one positioning portion of the speaker abutting against the at least one positioning flange.

6. The earphone of claim 5, wherein a central plane of each of the least one positioning flange is nonparallel to a joint plane between the first and second covers.

7. The earphone of claim 6, wherein the at least one positioning flange includes two positioning flanges protruding respectively out from the front and rear covers, the two positioning flanges of the front and rear covers cooperatively forming an annular flange.

8. The earphone of claim 1, wherein a sound tube extends out from a front end of the front cover, the sound tube defining an annular joint groove in an outer circumference thereof, the sound tube having an outer diameter gradually decreasing from the joint groove toward the rubber cap and forming an inclined outer surface, the earphone further comprising a rubber cap around the sound tube, the rubber cap having a joint flange protruding out toward the sound tube, the joint flange engaging in the joint groove to mount the rubber cap on the sound tube.

9. The earphone of claim 8, wherein the rubber cap defines an inclined groove in an inner surface thereof, the inclined groove matching the inclined outer surface of the sound tube.

10. The earphone of claim 1, wherein the front cover is hollow and defines a front chamber therein, a sound tube extending out from a front end of the front cover, the sound tube being hollow and defining a sound channel therein in communication with the front chamber, the sound channel expanding outwardly toward the front chamber to form a trumpet shape.

11. The earphone of claim 1, wherein the protrusion has a spherical shape, and the fixing groove also has a spherical shape for matching the protrusion.

12. The earphone of claim 11, wherein the protrusion is formed on the front cover, and the fixing groove is defined in the rear cover, the rear cover being cooperatively formed by an outer cover and an inner cover in the outer cover, the spherical fixing groove being cooperatively formed by a hemispheric first groove defined in an inner surface of the outer cover and a hemispheric second groove defined in an outer surface of the inner cover.

13. The earphone of claim 12, wherein the fixing flange extends out from the front cover toward the rear cover, the protrusion being formed on a free end of the fixing flange, the fixing flange defining a positioning cutout therein, the inner cover of the rear cover having a securing flange extending out toward the front cover, the securing flange of the inner cover defining a positioning cutout aligning with the positioning cutout of the front cover for positioning the front and rear covers accurately during assembly.

14. The earphone of claim 12, wherein the inner cover is made of a rigid material, and the outer cover is made of a material which has a rigidity less than that of the inner cover and a toughness greater than that of the inner cover.
